(19) United States
(12) Patent Application Publication
(10) Pub. No.: US 2021/0072493 A1
(43) Pub. Date: Mar. 11, 2021

(54) LENS MODULE AND ELECTRONIC DEVICE

(71) Applicant: AAC Optics Solutions Pte. Ltd., Singapore City (SG)

(72) Inventors: Yinlong Zhu, Shenzhen (CN); Gang Li, Shenzhen (CN)

(21) Appl. No.: 16/999,094

(22) Filed: Aug. 21, 2020

(30) Foreign Application Priority Data
Sep. 11, 2019 (CN) 201910860135.8

(51) Int. Cl. G02B 7/09; G02B 27/64

(52) U.S. Cl. CPC G02B 7/09; G02B 27/646

(57) ABSTRACT

The present invention provides a lens module and an electronic device. The lens module includes an autofocus assembly, an optical image stabilization assembly, and at least two elastic supporting members. The elastic supporting member includes a first connecting end, a second connecting end, a first extending portion, a second extending portion, a third extending portion and a fourth extending portion. The first extending portion, the second extending portion, the third extending portion and the fourth extending portion are all arranged on an outer side of the autofocus assembly. One end of the first connecting end away from the third extending portion is connected with the autofocus assembly, and one end of the second connecting end away from the fourth extending is connected with the optical image stabilization assembly. The lens module of the present invention has advantages of simple structure and small occupied space.

### FIELD OF THE PRESENT INVENTION

The present invention relates to the technical field of lens optical imaging, and more particularly to a lens module and an electronic device adopting the lens module.

### DESCRIPTION OF RELATED ART

In recent years, a high-performance lens module has been mounted on portable terminal, such as smartphone and tablet computer, and the high-performance lens module generally has an Auto Focusing (AF) function and an Optical Image Stabilization (OIS) function. The lens moves in a direction of an optical axis of the lens when the high-performance lens module performs the Auto Focusing function, and the lens moves in the direction perpendicular to the optical axis of the lens when the high-performance lens module performs the Optical Image Stabilization function. In the related art, the AF assembly is supported above the OIS assembly through four suspension wires. A plurality of other auxiliary components are arranged to ensure the supporting stability of the suspension wires, so that an overall structure of the lens module is complicated, and the volume is large. Moreover, if one of the suspension wires is broken, the AF assembly will lose its balance.

Therefore, it is desired to provide an improved lens module to solve the above-mentioned problem.

### SUMMARY OF THE PRESENT INVENTION

The first object of the present invention is to provide a lens module to solve the technical problem that an overall structure of the lens module is complicated.

The first object of the present invention can be achieved by the following technical solution. The present invention provides a lens module including an autofocus assembly, an optical image stabilization assembly and at least two elastic supporting members. The autofocus assembly and the optical image stabilization assembly are arranged at intervals in an optical axis direction of the lens module. The elastic supporting member includes a first connecting end, a second connecting end, and an elastic supporting member connected between the first connecting end and the second connecting end. The first connecting end is connected to the autofocus assembly, and the second connecting end is connected to the optical image stabilization assembly. The elastic supporting member is arranged on an outer side of the autofocus assembly. The elastic supporting body includes a first extending portion connecting to the first connecting end at one end, a second extending portion connecting to the second connecting end at one end, a third extending portion paralleled to the optical axis and a fourth extending portion paralleled to the optical axis. One end of the first extending portion away from the first connecting end is connected to an end of the second extending portion away from the second connecting end. Both the first extending portion and the second extending portion are perpendicular to the optical axis and perpendicular to each other. One end of the third extending portion is connected to the first connecting end, the other end is connected to the first extending portion. One end of the fourth extending portion is connected to the second connecting end, and the other end is connected to the second extending portion.

Furthermore, the autofocus assembly includes a first base and a first circuit board fixed on a side of the first base facing to the optical image stabilization assembly. The optical image stabilization assembly includes a second base and a second circuit board fixed on a side of the second base away from the autofocus assembly. The first connecting end is electrically connected to the first circuit board, and the second connecting end is electrically connected to the second circuit board.

Furthermore, a protruding post is arranged on a side of the first base facing to the optical image stabilization assembly. A mounting hole is arranged through the first connecting end. The first connecting end is connected with the first base by matching the protruding post with the mounting hole.

Furthermore, a groove is provided on a side of the first base facing to the optical image stabilization assembly. The groove has a bottom groove surface facing to the optical image stabilization assembly, and the protruding post is protruding from the bottom groove surface.

Furthermore, the second base is provided with a through hole penetrating thereof. The second connecting end is welded to the second circuit board. The fourth extending portion is arranged through the through hole and is connected with the second connecting end.

Furthermore, the first base includes a bottom plate and a surrounding wall, the surrounding wall is protrudingly arranged on an edge of the bottom plate away from the optical image stabilization assembly, and the surrounding wall is rectangular in shape with rounded corners. The elastic supporting body is extended from the middle of one side of the surrounding wall through the corner to the middle of the adjacent side.

Furthermore, the lens module is provided with four elastic supporting members. The four first connecting ends are arranged at equal intervals along the circumferential direction of the autofocus assembly, and the four second connecting ends are arranged at equal intervals along the circumference direction of the optical image stabilization assembly. Each of the first connecting end is connected to the adjacent second connecting end through the elastic supporting body in a counterclockwise or clockwise direction along the optical axis.

The second object of the present invention is to provide an electronic device including the above-mentioned lens module.

The beneficial effect of the present invention is as follow. By arranging at least two elastic supporting members for connecting to the autofocus assembly and the optical image stabilization assembly arranged at intervals, compared to the existing fixing method of suspension wires, the connection is more stable and concise, and the reliability is high. Besides, other complicated auxiliary components are not required in the connection, so it facilitates a miniaturization of structure of the lens module. Therefore, the lens module of the present invention has advantages of simple structure, small occupied space, and high reliability of the connection between the autofocus component and the optical image stabilization component.

### BRIEF DESCRIPTION OF THE DRAWINGS

FIG. 1 is an isometric view of a lens module according to an embodiment of the present invention.

FIG. 2 is an exploded view of the lens module according to the embodiment of the present invention.

FIG. 3 an isometric view of a first base according to the embodiment of the present invention.

FIG. 4 is an isometric view of an elastic supporting member matching with the first base each other according to the embodiment of the invention.

FIG. 5 an isometric view of a shape memory alloy wire according to the embodiment of the present invention.

FIG. 6 is an isometric view of the elastic supporting member according to the embodiment of the present invention.

FIG. 7 is an isometric view of the lens module without an upper housing according to the embodiment of the present invention.

FIG. 8 is a cross-sectional view taken along line A-A in FIG. 7.

FIG. 9 is a partially enlarged view of B part in FIG. 8.

The reference numbers in the drawings are as follows:

lens module 100, autofocus assembly 1, first base 11, a bottom plate 111, surrounding wall 112, groove 113, bottom groove surface 114, protruding post 115, first circuit board 12, optical image stabilization assembly 2, second base 21, through hole 211, second circuit board 22, driving member 23, binding wire clip 231, shape memory alloy wire 232, first wire body 233, second wire body 234, elastic supporting member 3, first connecting end 31, mounting hole 311, fixing portion 312, welding portion 313, second connecting end 32, elastic supporting body 33, first extending portion 331, second extending portion 332, third extending portion 333, fourth extending portion 334, upper housing 41, substrate 42.

### DETAILED DESCRIPTION OF THE EXEMPLARY EMBODIMENT

The present invention will be further described below with reference to the drawings and embodiments.

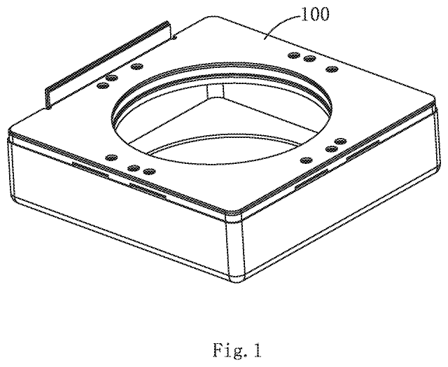

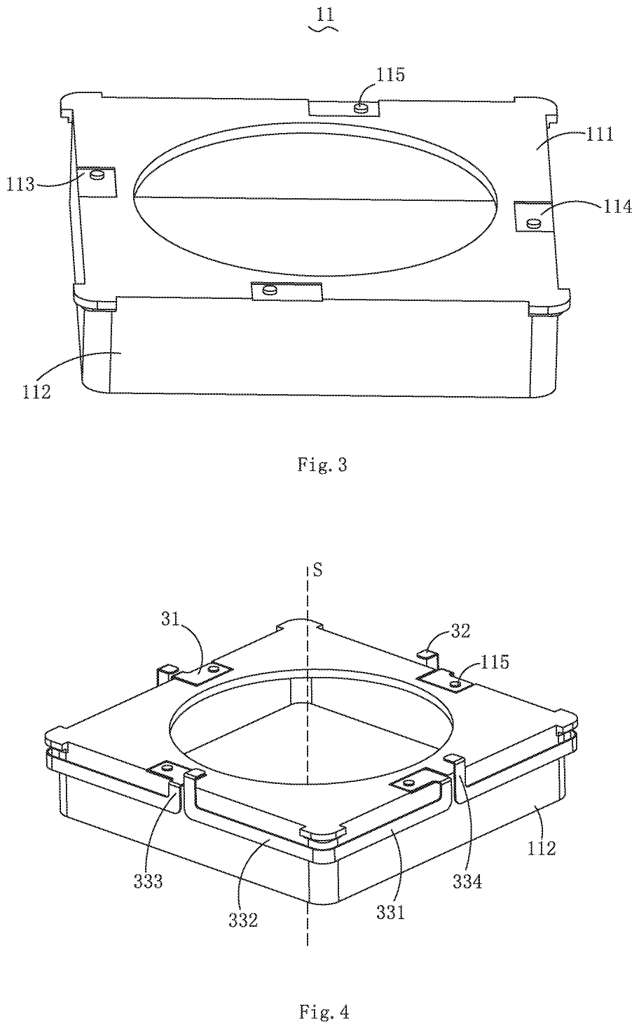

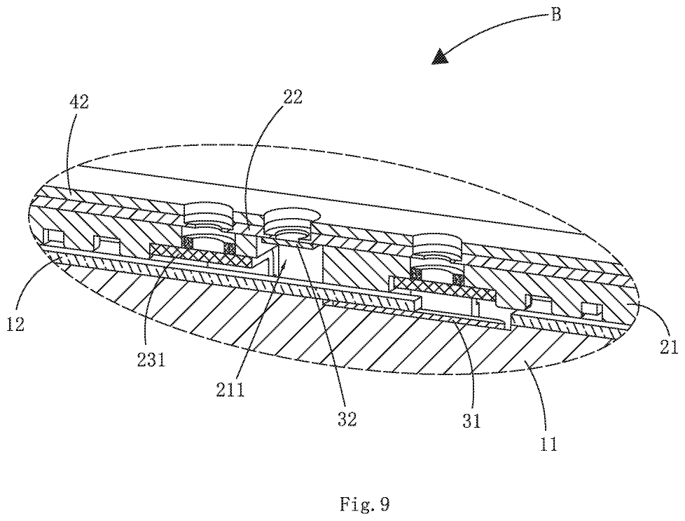

Please refer FIG. 1 to FIG. 9, the embodiment of the present invention provides a lens module 100, including a lens (not shown), an autofocus assembly 1, an optical image stabilization assembly 2, and at least two elastic supporting members 3. The lens is arranged on the autofocus assembly 1, the autofocus assembly 1 and the optical image stabilization assembly 2 are arranged at intervals in an optical axis S direction of the lens module 100. The elastic supporting member 3 includes a first connecting end 31, a second connecting end 32, and an elastic supporting body 33 connected between the first connecting end 31 and the second connecting end 32. The first connecting end 31 is connected with the autofocus assembly 1, and the second connecting end 32 is connected with the optical image stabilization assembly 2. In the present invention, by arranging at least two elastic supporting members 3 for connecting the autofocus assembly 1 and the optical image stabilization assembly 2 arranged at intervals, compared to the existing fixing method of suspension wires, the above connection is more stable and concise, and the reliability is high. Besides, other complicated auxiliary components are not required in the connection, so it facilitates a miniaturization of structure of the lens module 100. Therefore, the lens module 100 of the invention has advantages of simple structure, small occupied space, and high reliability of connection between the autofocus assembly 1 and the optical image stabilization assembly 2.

In the embodiment of the present invention, the elastic supporting member 3 is made of SUS304H material, which has advantages of good corrosion resistance and welding performance. In terms of stiffness, the reliability of the connection between the autofocus assembly 1 and the optical image stabilization assembly 2 can be completely ensured.

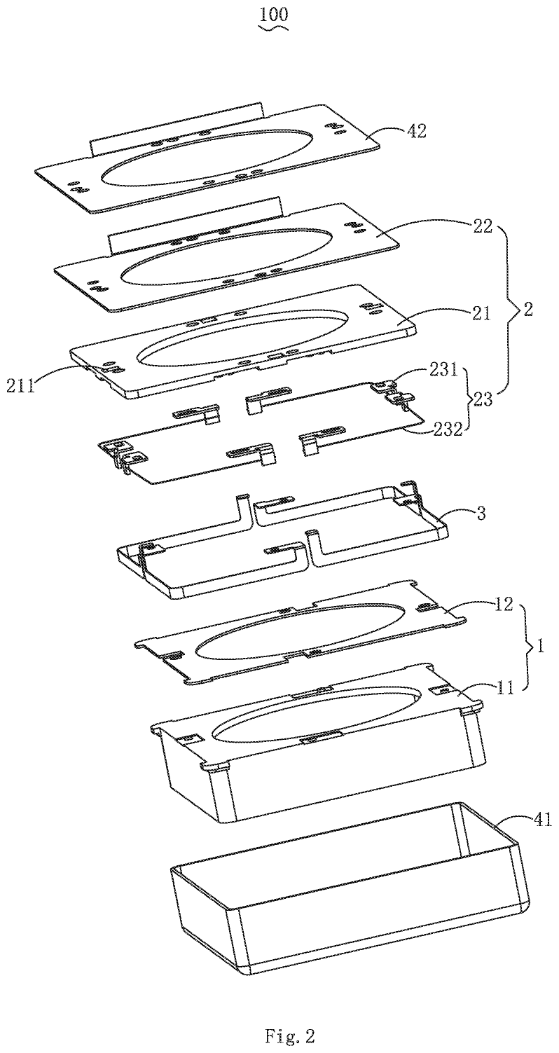

Please refer to FIG. 2 to FIG. 4, the autofocus assembly 1 includes a first base 11 and a first circuit board 12 fixed on a side of the first base 11 facing to the optical image stabilization assembly 2. The first base 11 includes a bottom plate 111 and a surrounding wall 112. The surrounding wall 112 is protrudingly arranged on an edge of the bottom plate 111 away from the optical image stabilization assembly 2. The surrounding wall 112 has a rectangular structure with rounded corners. The first connecting end 31 is arranged on a side of the bottom plate 111 facing to the first circuit board 12 and is electrically connected to the first circuit board 12. By arranging the first connecting end 31 on a side of the bottom plate 111 facing to the first circuit board 12, a size of the lens module 100 along the direction of the vertical optical axis S can be prevented from increasing. That is, the size of the lens module 100 in the direction perpendicular to the optical axis S is reduced.

A groove 113 is provided on a side of the bottom plate 111 facing to the first circuit board 12. The first connecting end 31 is fixed in the groove 113, so that both the size of the lens module 100 along the direction of the optical axis S and the side of the lens module 100 along the direction perpendicular to the optical axis S can be reduced. The groove 113 has a bottom groove surface 114 facing to the first circuit board 12, and a protruding post 115 is protruding from the bottom groove surface 114. The first connecting end 31 is provided with a mounting hole 311 penetrating thereof, the first connecting end 31 is connected to the bottom plate 111 by matching the protruding post 115 with the mounting hole 311. By matching the protruding post 115 with the mounting hole 311, the stability of the elastic supporting member 3 fixed on the autofocus assembly 1 is enhanced. It can be understood that the groove 113 may not be provided on the side of the bottom plate 111 facing to the first circuit board 12. That is, the protruding post 115 is directly and protrudingly arranged on the side of the bottom plate 111 facing to the first circuit board 12.

The optical image stabilization assembly 2 includes a second base 21, a second circuit board 22 fixed on a side of the second base 21 away from the autofocus assembly 1, and a driving member 23 for driving the autofocus assembly 1 to move along the direction perpendicular to the optical axis S. The second base 21 is provided with a through hole 211 penetrating thereof, the elastic support body 33 is partially inserted into the through hole 211, and the second connecting end 32 is welded on the second circuit board 22. By welding the second connecting end 32 on the second circuit board 22, not only the electrical connection between the elastic supporting member 3 and the optical image stabilization assembly 2 is ensured, but also the stability of the connection between the elastic supporting member 3 and the optical image stabilization assembly 2 is ensured. Furthermore, the stability of the spaced connection between the autofocus assembly 1 and the optical image stabilization assembly 2 is ensured. In this embodiment, the second connecting end 32 is extended from the elastic supporting body 33 toward a direction close to the optical axis S, thus to prevent the size of the lens module 100 along the direction perpendicular to the optical axis S from increasing. That is, the size of the lens module 100 along the direction perpendicular to the optical axis S is reduced.

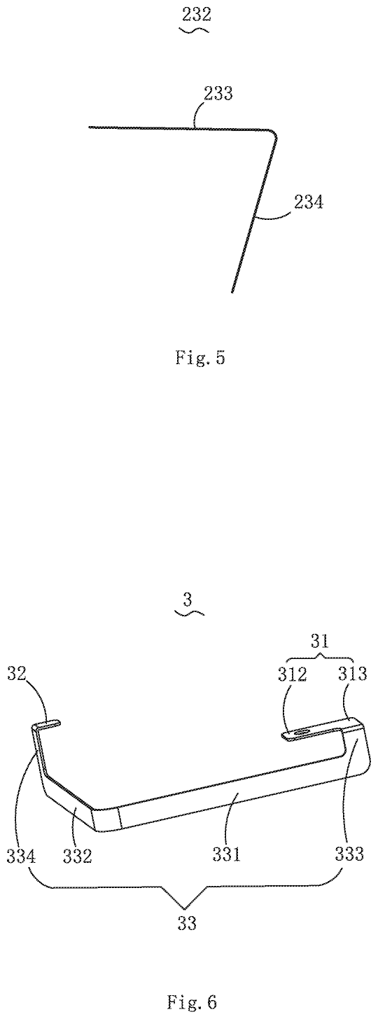

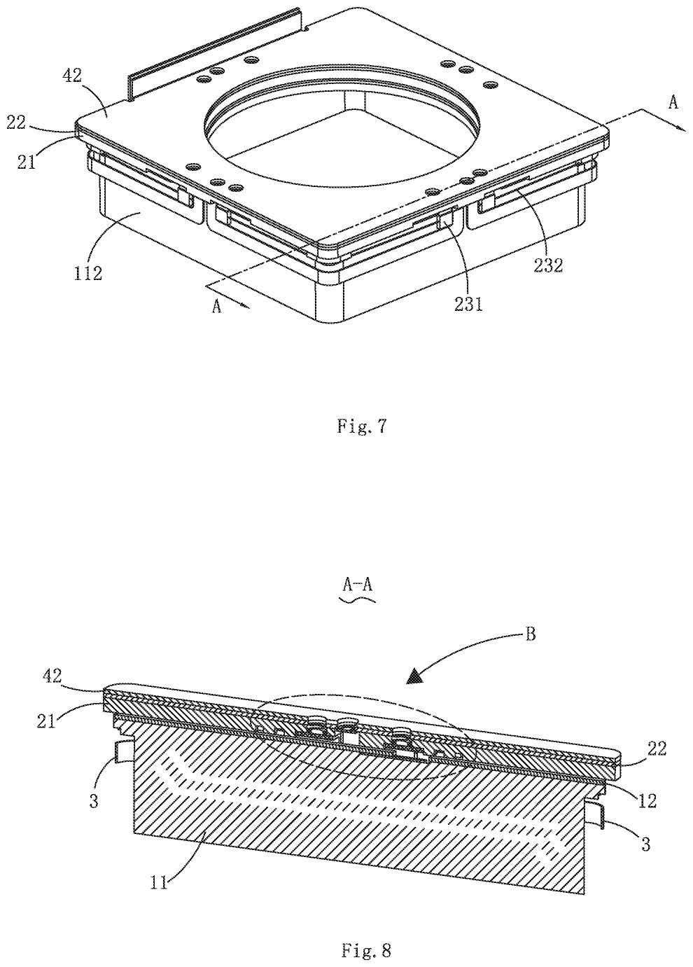

Please refer to FIG. 2, FIG. 5 and FIG. 7, the driving member 23 includes a plurality of shape memory alloy wires 232 and binding wire clips 231 disposed at both ends of the shape memory alloy wires 232. The shape memory alloy wire 232 includes a first wire body 233 and a second wire body 234. One end of the first wire body 233 is connected to one end of the second wire body 234, the other end of the first wire body 233 and the other end of the second wire body 234 are respectively connected with a binding wire clip 231. The first wire body 233 and the second wire body 234 are perpendicular to each other. That is, the first wire body 233 and the second wire body 234 are configured as an L shape. The binding wire clip 231 is fixed on a side of the second base 21 facing to the autofocus assembly 1, and the shape memory alloy wires 232 are provided on an outer side of the surrounding wall 112. The ends where the first wire body 233 is connected to the second wire body 234 are fixed on the rounded corners of the surrounding wall 112 by glue. The other end of the first wire body 233 is arranged at the middle of a side of the surrounding wall 112, and the other end of the second wire body 234 is arranged at the middle of an adjacent side of the surrounding wall 112. That is, the shape memory alloy wire 232 is extended from the middle of one side of the surrounding wall 112 through the corner to the middle of the adjacent side. In this embodiment, the first wire body 233 is integrally formed with the second wire body 234, and the four shape memory alloy wires 232 are provided thereof. Each shape memory alloy wire 232 is arranged at equal intervals along the circumference of the autofocus assembly 1. Accordingly, eight wire binding clips 231 are provided thereof, and each set of two binding wire clips 231 connected to a same shape memory alloy wire 232 are arranged at equal intervals along the circumference of the optical image stabilization assembly.

After a power is supplied to the shape memory alloy wire 232, the temperature rises so the shape memory alloy wire 232 is contracted to generate a driving force to form an angle of 45° C. with the first wire body 233 or the second wire body 234, so that the autofocus assembly 1 is moved in the direction perpendicular to the optical axis S to achieve optical image stabilization function. The four shape memory alloy wires 232 are arranged at equal intervals along the circumferential direction of the autofocus assembly 1, so that the autofocus assembly 1 can be moved toward four directions.

Please refer to FIG. 6, the elastic supporting body 33 includes a first extending portion 331 connected to the first connecting end 31 at one end and a second extending portion 332 connected to the second connecting end 32 at one end. One end of the first extending portion 331 away from the first connecting end 31 is connected to the end of the second extending portion 332 away from the second connecting end 32. Both the first extending portion 331 and the second extending portion 332 are perpendicular to the optical axis S, and the first extending portion 331 and the second extending portion 332 are perpendicular to each other. That is, the first extending portion 331 and the second extending portion 332 are configured to be an L-shaped, in this way, the elastic supporting member 3 can provide the autofocus assembly 1 with a restoring force in a direction perpendicular to the optical axis S.

The elastic supporting body 33 may be provided on the autofocus assembly 1 or the optical image stabilization assembly 2. As a preferred embodiment, the elastic supporting member 3 is arranged on an outer side of the surrounding wall 112 of the autofocus assembly 1. Specifically, the elastic supporting body 33 is extended from the middle of a side of the surrounding wall 112 through the corner to the middle of an adjacent side. Please refer to FIG. 4, and FIG. 6 to FIG. 9, the elastic supporting body 33 further includes a third extending portion 333 and a fourth extending portion 334 both paralleled to the optical axis S. One end of the third extending portion 333 is connected to the first connecting end 31, and the other end is connected to the first extending 331. One end of the fourth extending portion 334 is arranged through the through hole 211 and is connected to the second connecting end 32, and the other end is connected to the second extending portion 332. The first extending portion 331 can be extended from the bottom plate 111 to the outside of the surrounding wall 112 by setting the third extending portion 333. The second extending portion 332 can be extended from the second circuit board 22 to the outside of the surrounding wall 112 by setting the fourth extending portion 334. The above structure is simple, a size of the lens module 100 along the optical axis S direction is reduced at the same time. It can be understood that the elastic supporting member 3 may also be disposed on a side of the bottom plate 111 opposite to the first circuit board 12. When the elastic supporting member 3 is disposed on the side of the bottom plate 111 opposite to the first circuit board 12, the third extending portion 333 is not required to be designed for the elastic supporting body 33.

Please refer to FIG. 4 and FIG. 7, there are four elastic supporting members 3. The four first connecting ends 31 are arranged at equal intervals along the circumferential direction of the autofocus assembly 1, and the four second connecting ends 32 are arranged at equal intervals along the circumferential direction of the optical image stabilization assembly 2. Each of the first connecting end 31 is connected to the adjacent second connecting end 32 through the elastic supporting body 33 in a counterclockwise or clockwise direction along the optical axis S. In the present embodiment, each of the first connecting end 31 is connected to the adjacent second connecting end 32 through the elastic supporting body 33 in a counterclockwise direction along the optical axis S.

In this embodiment, the positions of each elastic supporting body 33 and each shape memory alloy wires 232 are arranged correspondingly. After one of the shape memory alloy wires 232 is contracted, the optical image stabilization function has been realized, and the corresponding elastic supporting body 33 forces the autofocus assembly 1 to move to the original position with its own characteristics. That is, the elastic supporting body 33 generates a restoring force to the autofocus assembly 1.

Please refer to FIG. 6 again, the first connecting end 31 includes a fixing portion 312 and a welding portion 313. A mounting hole 311 is provided in the fixing portion 312, and the first connecting end 31 is fixed in the groove 113 through the fixing portion 312. Meanwhile the first connecting end is welded on the first circuit board 12 through the welding portion 313. In the case the elastic supporting member 3 is electrically connected to the autofocus assembly 1, the stability of the elastic supporting member 3 fixed on the autofocus assembly 1 is further strengthened.

Please refer to FIG. 1 again, the lens module 100 further includes a housing. The housing includes an upper housing 41 surrounding the autofocus assembly 1 and a substrate 42 arranged on a side of the second circuit board 22 far from the autofocus assembly 1. With this structure, the internal components of the lens module 100 are prevented from pollution, thus prolonging their service life. The present invention further provides an electronic device, which includes the above-mentioned lens module.

The above description is only preferred embodiment of the present invention, and it should be noted that those skilled in the art can also make improvements without departing from the inventive concept of the present invention, but these improvements all belong to the protection scope of the invention.

What is claimed is:

1. A lens module, comprising an autofocus assembly, an optical image stabilization assembly, and at least two elastic supporting members, wherein the autofocus assembly and the optical image stabilization assembly are arranged at intervals in the optical axis direction of the lens module; the elastic supporting member includes a first connecting end, a second connecting end, and an elastic supporting member connected between the first connecting end and the second connecting end; the first connecting end is connected to the autofocus assembly, the second connecting end is connected to the optical image stabilization assembly, and the elastic supporting member is arranged on an outer side of the autofocus assembly; the elastic supporting member includes a first extending portion connecting to the first connecting end at one end, a second extending portion connecting to the second connecting end at one end, a third extending portion paralleled to the optical axis and a fourth extending portion paralleled to the optical axis; one end of the first extending portion away from the first connecting end is connected to an end of the second extending portion away from the second connecting end, both the first extending portion and the second extending portion are perpendicular to the optical axis and perpendicular to each other; one end of the third extending portion is connected to the first connecting end, the other end of the third extending portion is connected to the first extending portion; one end of the fourth extending portion is connected to the second connecting end, and the other end of the fourth extending portion is connected to the second extending portion.

2. The lens module according to claim 1, wherein the autofocus assembly includes a first base and a first circuit board fixed on a side of the first base facing to the optical image stabilization assembly; the optical image stabilization assembly includes a second base and a second circuit board fixed on a side of the second base away from the autofocus assembly; the first connecting end is electrically connected to the first circuit board, and the second connecting end is electrically connected to the second circuit board.

3. The lens module according to claim 2, wherein a protruding post is provided on a side of the first base facing to the optical image stabilization assembly, a mounting hole is arranged through the first connecting end, and the first connecting end is connected with the first base by matching the protruding post with the mounting hole.

4. The lens module according to claim 3, wherein a groove is provided on a side of the first base facing to the optical image stabilization assembly, the groove has a bottom groove surface opposite to the optical image stabilization assembly, and the protruding post is arranged on the bottom groove surface protrudingly.

5. The lens module according to claim 2, wherein the second base is provided with a through hole penetrating thereof, the second connecting end is welded to the second circuit board, and the fourth extending portion is arranged through the through hole and is connected with the second connecting end.

6. The lens module according to claim 2, wherein the first base includes a bottom plate and a surrounding wall, the surrounding wall is protrudingly arranged on an edge of the bottom plate away from the optical image stabilization assembly, the surrounding wall is rectangular in shape with rounded corners, and the elastic supporting body is extended from the middle of one side of the surrounding wall through the corner to the middle of the adjacent side.

7. The lens module according to claim 2, wherein the lens module is provided with four elastic supporting members, the four first connecting ends are arranged at equal intervals along the circumferential direction of the autofocus assembly, and the four second connecting ends are arranged at equal intervals along the circumference direction of the optical image stabilization assembly; each of the first connecting end is connected to the adjacent second connecting end through the elastic supporting body in a counterclockwise or clockwise direction along the optical axis.

8. An electronic device, wherein the electronic device includes a lens module according to claim 1.
